(19) United States
(12) Patent Application Publication
(10) Pub. No.: US 2025/0187473 A1
(43) Pub. Date: Jun. 12, 2025

(54) CHARGING PILE DEVICE AND RELATED SELF-EXAMINATION METHOD

(71) Applicant: Wistron Corporation, New Taipei City (TW)

(72) Inventors: Tsung-Han Yu, New Taipei City (TW); Cheng-Wei Huang, New Taipie City (TW); Chih-Fong Huang, New Taipei City (TW); Wen-Ju Chen, New Taipei City (TW)

(73) Assignee: Wistron Corporation, New Taipei City (TW)

(21) Appl. No.: 18/599,155

(22) Filed: Mar. 7, 2024

(30) Foreign Application Priority Data
Dec. 12, 2023 (TW) 112148212

(51) Int. Cl. B60L 53/62; B60L 53/30

(52) U.S. Cl. CPC B60L 53/62; B60L 53/305; B60L 2260/42

(57) ABSTRACT

A charging pile device and related self-examination method are provided. The charging pile device includes a control pilot, a control unit, a micro-controller. The control pilot is configured to indicate a charging state of the charging pile device. The control unit includes a control pile state checking circuit and an alternating current charging checking circuit. The micro-controller unit is configured to change an operation voltage of the control pilot via the control pile state checking circuit of the control unit in response to the charging pile being under a non-charging state, and to generate a first charging checking signal to conduct a relay according to a checking signal via the alternating current charging checking circuit of the control unit to form a current path of the relay, a current transformer, and the control unit in response to the charging pile being under the non-charging state.

### BACKGROUND OF THE INVENTION

### 1. Field of the Invention

The present invention relates to a charging pile device and related self-examination method, and more particularly, to a charging pile device and related self-examination method capable of performing self-examination to improve user experience.

### 2. Description of the Prior Art

With the popularity of electric cars, many users install home charging stations. Based on UL2231 standard of Personnel Protection Systems for Electric Vehicle supply Circuits: General Requirements, conventional alternating current (AC) charging pile includes RCD/CCID leakage current self-examination, relay welding detection and ground protection mechanism.

Although the self-examination techniques of the UL2231 standard of Personnel Protection Systems for Electric Vehicle may insure a reliability of the safety protection function of the charging pile, other functions, e.g. on/off of the relay, transmission/reception of the electric car communication interface and detection of voltage and current values are not regulated. Therefore, when the relay of the AC charging pile or the communication interface is in malfunction, the charging for electric cars cannot be performed and causes inconveniences to the users.

Therefore, improvements are necessary to the conventional technique.

### SUMMARY OF THE INVENTION

In light of this, the present invention provides a charging pile device and related self-examination method to perform the self-examination and improve the user experience.

An embodiment of the present invention discloses a charging pile device, comprises a first power source; a second power source, configured to provide power via a charging plug in response to the charging pile device being coupled to an alternating current (AC) power source; a current transformer, configured to detect a current of the charging pile device; a relay; a control pilot, configured to indicate a charging state of the charging pile device; a control unit, including a control pile state checking circuit and an alternating current (AC) charging checking circuit; and a micro-controller unit, configured to change an operation voltage of the control pilot via the control pile state checking circuit of the control unit to switch an operation state of the control pilot in response to the charging pile being under a non-charging state; and to generate a first charging checking signal to conduct the relay according to a checking signal via the AC checking circuit of the control unit to form a current path of the relay, the current transformer and the control unit in response to the charging pile being under the non-charging state.

Another embodiment of the present invention discloses a self-examination method, for a charging pile device, wherein the charging pile device includes a micro-controller unit, a first power source, a second power source, a control pilot, a current transformer, a relay and a control unit, and the self-examination method comprises changing, by the micro-controller unit, an operation voltage of the control pilot via a control pile state checking circuit of the control unit to switch an operation state of the control pilot in response to the charging pile device being under a non-charging state; and generating, by the micro-controller unit, a first charging checking signal to conduct the relay according to a checking signal via an alternating current charging (AC) checking circuit of the control unit to form a current path of the relay, the current transformer and the control unit in response to the charging pile being under the non-charging state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a charging pile device according to an embodiment of the present invention.

FIG. 2 is a schematic diagram of a control unit according to an embodiment of the present invention.

FIG. 3 is a schematic diagram of a control pile state checking circuit according to an embodiment of the present invention.

FIG. 4 is a schematic diagram of an alternating current (AC) charging checking circuit according to an embodiment of the present invention.

FIG. 5 and FIG. 6 are schematic diagrams of a self-examination method according to an embodiment of the present invention.

### DETAILED DESCRIPTION

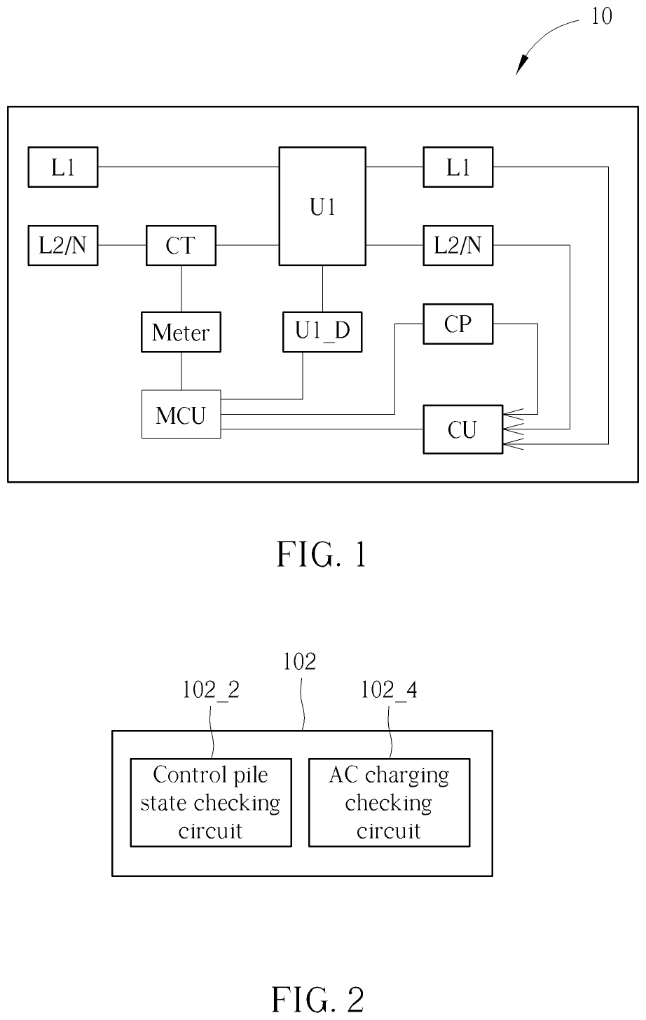

Please refer to FIG. 1, which is a schematic diagram of a charging pile device 10 according to an embodiment of the present invention. The charging pile device 10 includes a first power source L1, a second power source L2/N, a current transformer CT, a relay U1, a relay driver U1_D, a control pilot CP, a control unit CU and a micro-controller unit MCU. The charging pile device 10 may be a commercial charging pile device or a home charging pile device to charge an electric car via a charging plug when connected. The first power source L1 and the second power source L2/N of the charging pile device 10 are utilized for providing power to an electric device, e.g. electric cars, via the charging plug when the charging pile device 10 is connected to an alternating current (AC). The current transformer CT is utilized for detecting a current of the charging pile device 10. The control pilot CP is utilized for indicating a charging state of the charging pile device 10 when connected to the electric device. The relay driver U1_D is utilized for driving the relay U1.

In an embodiment, the micro-controller unit MCU of the charging pile device 10 may determine a charging state between the charging pile device 10 and the electric device according to an operation voltage CP_V of the control pilot CP. The micro-controller unit MCU may change the operation voltage CP_V of the control pilot CP to switch an operation state of the control pilot CP, when the charging pile device 10 is under a non-charging state and to generate a charging checking signal GPIO_charging_check_A to conduct the relay U1 according to a checking signal, such that a current path of the relay U1, a current transformer CT and the control unit CU is formed. In this way, whether the relay U1 and the current transformer CT of the charging pile device 10 are normally operated or not is determined, wherein the checking signal may be generated periodically, or triggered by a user with a remote application program to activate the charging pile device 10 for self-examination.

In addition, the charging pile device 10 according to an embodiment of the present invention may further include a residual current device (RCD), a charging circuit interrupting device (CCID), a ground detection device, a welding check device, which are not illustrated in the figures, to detect whether leakage current of AC or direct current of the charging pile device 10 exists or not, whether devices for monitoring the charging pile are correctly mounted or not, and whether the relay U1 is correctly coupled before the charging pile device 10 enters the charging state.

In details, when the operation voltage CP_V of the control pilot CP is 12V, i.e. the control pilot CP is in a state State_A, the control pilot CP is not connected to the electric car yet, i.e. an idle state; when the operation voltage CP_V of the control pilot CP is 9V, i.e. the control pilot CP is in a state State_B, the charging plug is connected to the electric car but not charging yet; when the operation voltage CP_V of the control pilot CP is 6V, i.e. the control pilot CP is in a state State_C, the charging pile device 10 is charging for the electric car, wherein transition timings of 12V, 9V and 6V of the operation voltage CP_V of the control pilot CP are determined by the electric car. In other words, the transitions between the states State_A, State_B, State C of the control pilot CP can only be performed when connected to the electric car.

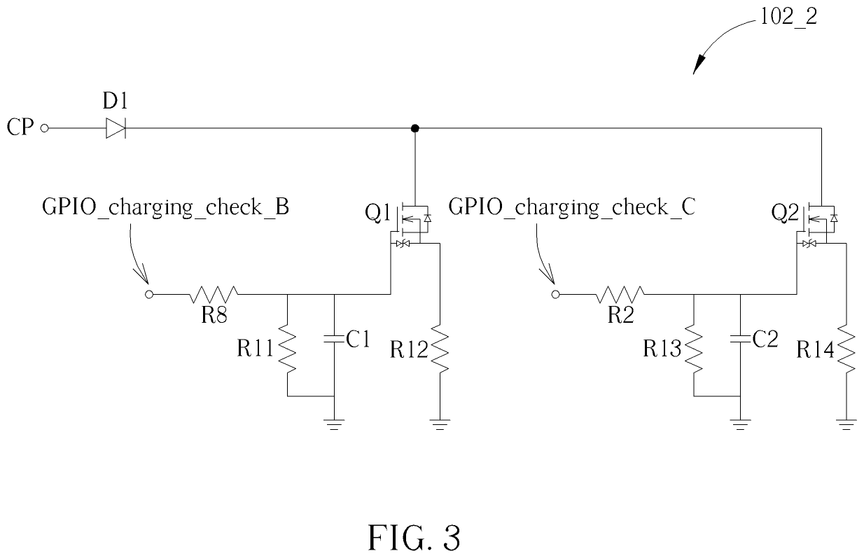

In details, please refer to FIG. 2, which is a schematic diagram of the control unit CU according to an embodiment of the present invention. In an embodiment, the control unit CU of the charging pile device 10 further includes a control pile state checking circuit 102_2 and an alternating current (AC) charging checking circuit 102_4.

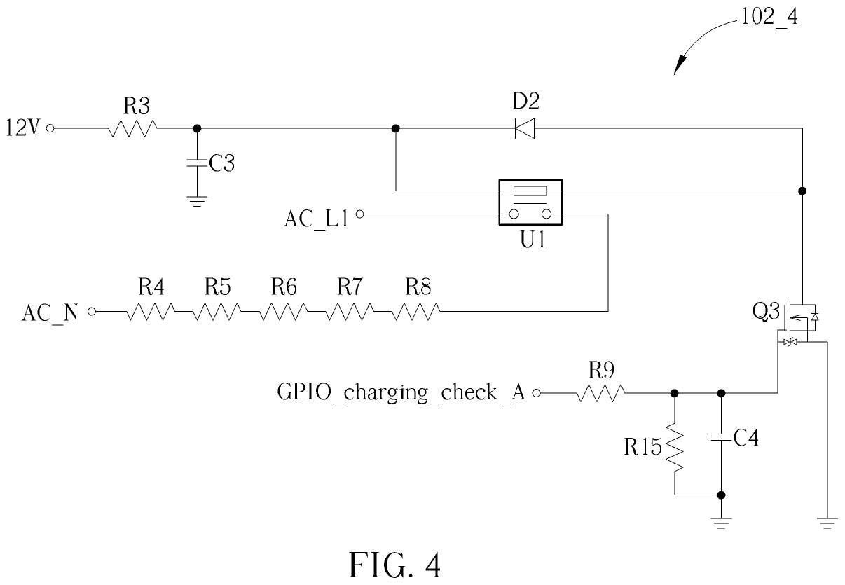

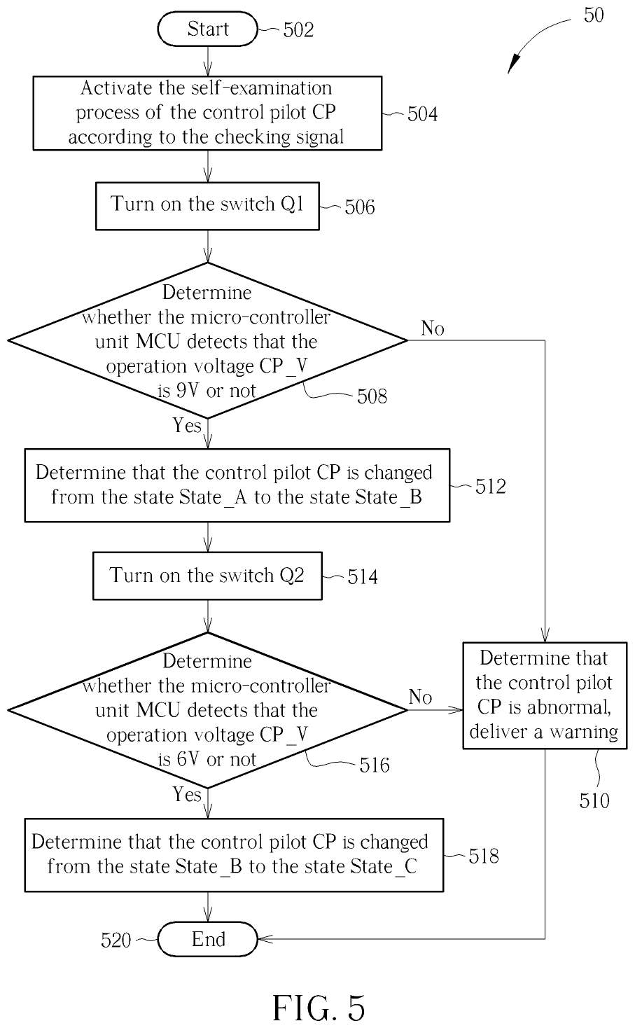

Please refer to FIG. 3 and FIG. 4, FIG. 3 is a schematic diagram of the control pile state checking circuit 102_2 according to an embodiment of the present invention. FIG. 4 is a schematic diagram of the AC charging checking circuit 102_4 according to an embodiment of the present invention. The control pile state checking circuit 102_2 includes a diode D1, switches Q1, Q2, resistors R1, R2, R11, R12, R13, R14 and capacitors C1, C2. The AC charging checking circuit 102_4 includes the relay U1, a diode D2, a switch Q3, capacitors C3, C4, resistors R3, R4, R5, R6, R7, R8, R9, R15.

As can be known in FIG. 1, the control unit CU is coupled to the micro-controller unit MCU for receiving charging checking signals GPIO_charging_check_B, GPIO_charging_check_C from the micro-controller unit MCU to check the charging pile device 10. When the charging pile device 10 is in the idle mode, the charging checking signals GPIO_charging_check_B and the charging checking signals GPIO_charging_check_C are at a low voltage level, e.g. logic 0, i.e. logic=0. At this time, the switches Q1, Q2 are not conducted; the operation voltage CP_V of the control pilot CP is 12V. Notably, when the operation voltage CP_V is 12V, the self-examination process of the charging pile device 10 according to an embodiment of the present invention is not performed.

When the charging pile device 10 receives the checking signal, which is periodically generated or triggered by the user), the control unit CU simulates the state of the operation voltage CP_V in 9V, such that the charging pile device 10 considers that the charging plug is connected to the electric car. In this situation, the micro-controller unit MCU changes the charging checking signals GPIO_charging_check_B to a high voltage level, e.g. logic 1, i.e. logic=1, to conduct the switch Q1, and the operation voltage CP_V is decreased to 9V with a voltage division of the resistor R12. When the control pilot CP of the charging pile device 10 detects that the operation voltage CP_V is 9V, the control unit CU according to an embodiment of the present invention may determine that the state State_B of the charging pile device 10 is normally operated.

Notably, during the detection process for the state State_B, the charging checking signal GPIO_charging_check_C is at the low voltage level, e.g. the logic 0, the switch Q2 is not conducted. In addition, in an example, the resistor R12 is 2.74 kOhm.

Then, the control unit CU simulates the state of the operation voltage CP_V in 6V, such that the charging pile device 10 considers that the charging plug is ready to charge the electric car. The micro-controller unit MCU changes the charging checking signal GPIO_charging_check_C to the high voltage level, e.g. the logic 1, to conduct the switch Q2. The operation voltage CP_V is decreased to 6V with a voltage division of the resistor R14. When the control pilot CP of the charging pile device 10 detects that the operation voltage CP_V is 6V, the control unit CU according to an embodiment of the present invention may determine that the state State_C of the charging pile device 10 is normally operated.

Notably, during the detection process for the state State_C, the micro-controller unit MCU changes the charging checking signals GPIO_charging_check_B to the low voltage level, e.g. the logic 0, the switch Q1 is not conducted. In an embodiment, the resistor R14 may be 887 Ohm.

In this way, the micro-controller unit MCU switches the charging checking signals GPIO_charging_check_B and the charging checking signals GPIO_charging_check_C to change the operation voltage CP_V, which simulates the state the control pilot CP of the electric car to check whether the state of the charging pile device 10 is operated normally or not.

On the other hand, the control unit CU according to an embodiment of the present invention checks the relay U1 and the current transformer CT through the AC charging checking circuit 102_4. In details, the micro-controller unit MCU changes the charging checking signal GPIO_charging_check_A from the low voltage level, e.g. the logic 0 to the high voltage level, e.g. the logic 1, to conduct the switch Q3 and the relay U1. Thus, a current AC L1 from the first power source L1 of the charging pile device 10 passes through the relay U1 and the resistors R4, R5, R6, R7, R8, and then flows back to the second power source L2/N, the current path between the first power source L1 and the second power source L2/N is formed.

As can be known from FIG. 4, when the current path between the first power source L1 and the second power source L2/N is conducted, the current enters the charging pile device 10 and passes through the relay U1, the control unit CU, the resistors R4, R5, R6, R7, R8 and the current transformer CT, the relay U1 is determined as normally operated and the current transformer CT may detect the current. In an embodiment, the micro-controller unit MCU may further include a meter unit Meter to record a voltage current passing through the current transformer CT to determine whether the relay U1 and the current transformer CT are normally operated or not.

In an embodiment, the resistors R4, R5, R6, R7, R8 may respectively be 47 Ohm, and the cascaded resistor value is 235 Ohm, around 1A current may be obtained, which may be taken as a fixed value for the self-examination of the current transformer CT.

The self-examination process of the control unit CU of the charging pile device 10 for checking the control pilot CP, the relay U1, the current transformer CT may be concluded as a self-examination method 50 and a self-examination method 60.

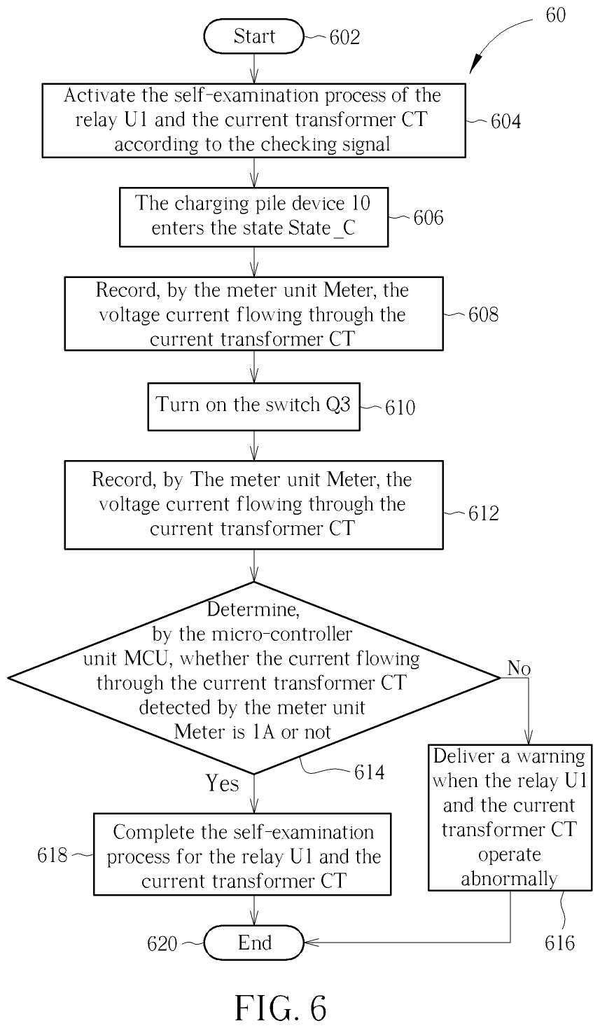

The self-examination method 50 is related to the checking process of the control pilot CP, as shown in FIG. 5, the self-examination method 50 includes the following steps:
Step 502: Start;
Step 504: Activate the self-examination process of the control pilot CP according to the checking signal;
Step 506: Turn on the switch Q1;
Step 508: Determine whether the micro-controller unit MCU detects that the operation voltage CP_V is 9V or not, if yes, goes to step 512, if no, goes to step 510;
Step 510: Determine that the control pilot CP is abnormal, deliver a warning;
Step 512: Determine that the control pilot CP is changed from the state State_A to the state State_B;
Step 514: Turn on the switch Q2;
Step 516: Determine whether the micro-controller unit MCU detects that the operation voltage CP_V is 6V or not, if yes goes to step 518, if no, goes to step 510;
Step 518: Determine that the control pilot CP is changed from the state State_B to the state State_C;
Step 520: End.

The self-examination method 60 is related to the checking process of the relay U1 and the current transformer CT, as shown in FIG. 6, the self-examination method 60 includes the following steps:
Step 602: Start;
Step 604: Activate the self-examination process of the relay U1 and the current transformer CT according to the checking signal;
Step 606: The charging pile device 10 enters the state State_C;
Step 608: Record, by the meter unit Meter, the voltage current flowing through the current transformer CT;
Step 610: Turn on the switch Q3;
Step 612: Record, by the meter unit Meter, the voltage current flowing through the current transformer CT;
Step 614: Determine, by the micro-controller unit MCU, whether the current flowing through the current transformer CT detected by the meter unit Meter is 1 A or not, if yes, goes to step 618, if no, goes to step 616;
Step 616: Deliver a warning when the relay U1 and the current transformer CT operate abnormally;
Step 618: Complete the self-examination process for the relay U1 and the current transformer CT;
Step 620: End.

Further details about the operation method of the self-examination method 50 and the self-examination method 60 can be known by referring to the embodiments of the embodiments of the charging pile device 10 above, and are therefore not narrated here for brevity.

Therefore, the user may remotely check whether the charging pile device 10 according to an embodiment of the present invention is normally operated or not with a wired/wireless method, to avoid chances of malfunction of the charging pile device 10.

Notably, those skilled in the art may properly design the charging pile device according to different system requirements. For example, elements of the control pile state checking circuit and the AC charging checking circuit, the switching of charging checking signals of the operation voltage of the control pilot, may all be adjusted according to different system requirements, and not limited thereto.

In summary, the present invention provides a charging pile device and related self-examination method to perform the self-examination process without connecting to electric cars to improve the user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging pile device, comprising:
a first power source;
a second power source, configured to provide power via a charging plug in response to the charging pile device being coupled to an alternating current (AC) power source;
a current transformer, configured to detect a current of the charging pile device;
a relay;
a control pilot, configured to indicate a charging state of the charging pile device;
a control unit, including a control pile state checking circuit and an alternating current (AC) charging checking circuit; and
a micro-controller unit, configured to change an operation voltage of the control pilot via the control pile state checking circuit of the control unit to switch an operation state of the control pilot in response to the charging pile being under a non-charging state; and to generate a first charging checking signal to conduct the relay according to a checking signal via the AC checking circuit of the control unit to form a current path of the relay, the current transformer and the control unit in response to the charging pile being under the non-charging state.

2. The charging pile device of claim 1, wherein the micro-controller unit is configured to switch the operation state of the control pilot according to a second charging checking signal and a third charging checking signal, wherein the second charging checking signal and the third charging checking signal are generated by the micro-controller unit according to the checking signal.

3. The charging pile device of claim 2, wherein the control pilot is under a first operation state in response to the second charging checking signal and the third charging checking signal being at a first voltage level.

4. The charging pile device of claim 3, wherein the control pilot is under a second operation state in response to the second charging checking signal being at a second voltage level and the third charging checking signal being at the first voltage level.

5. The charging pile device of claim 4, wherein the micro-controller unit is configured to determine that the control pilot is normally operated in response to the control pilot being changed from the first operation state to the second operation state.

6. The charging pile device of claim 3, wherein the control pilot is switched to a third operation state in response to the second charging checking signal being changed from the second voltage level to the first voltage level and the third charging checking signal being changed from the first voltage level to the second voltage level.

7. The charging pile device of claim 6, wherein the micro-controller unit is configured to determine that the control pilot is normally operated in response to the control pilot being changed from the second operation state to the third operation state.

8. The charging pile device of claim 1, wherein the relay is conducted in response to the first charging checking signal being changed from a first voltage level to a second voltage level, such that the current path of the first power source, the relay, the control unit, and the second power source is formed.

9. The charging pile device of claim 8, wherein the micro-controller unit is configured to determine whether the relay and the current transformer are normally operated or not according to a voltage current passing through the current transformer recorded by a meter unit.

10. The charging pile device of claim 1, wherein the checking signal is generated according to a cycle or a user.

11. A self-examination method, for a charging pile device, wherein the charging pile device includes a micro-controller unit, a first power source, a second power source, a control pilot, a current transformer, a relay and a control unit, and the self-examination method comprising:
changing, by the micro-controller unit, an operation voltage of the control pilot via a control pile state checking circuit of the control unit to switch an operation state of the control pilot in response to the charging pile device being under a non-charging state; and
generating, by the micro-controller unit, a first charging checking signal to conduct the relay according to a checking signal via an alternating current charging (AC) checking circuit of the control unit to form a current path of the relay, the current transformer and the control unit in response to the charging pile being under the non-charging state.

12. The self-examination method of claim 11, wherein the micro-controller unit is configured to switch the operation state of the control pilot according to a second charging checking signal and a third charging checking signal, wherein the second charging checking signal and the third charging checking signal are generated by the micro-controller unit according to the checking signal.

13. The self-examination method of claim 12, wherein the control pilot is under a first operation state in response to the second charging checking signal and the third charging checking signal being at a first voltage level.

14. The self-examination method of claim 13, wherein the control pilot is under a second operation state in response to the second charging checking signal being at a second voltage level and the third charging checking signal is at the first voltage level, and the second charging checking signal and the third charging checking signal are generated by the micro-controller unit according to the checking signal.

15. The self-examination method of claim 14, wherein the micro-controller unit is configured to determine that the control pilot is normally operated in response to the control pilot being changed from the first operation state to the second operation state.

16. The self-examination method of claim 13, wherein the control pilot is switched to a third operation state in response to the second charging checking signal being changed from the second voltage level to the first voltage level and the third charging checking signal being changed from the first voltage level to the second voltage level.

17. The self-examination method of claim 16, wherein the micro-controller unit is configured to determine that the control pilot is normally operated in response to the control pilot being changed from the second operation state to the third operation state.

18. The self-examination method of claim 11, wherein the relay is conducted in response to the first charging checking signal being changed from a first voltage level to a second voltage level, such that the current path of the first power source, the relay, the control unit, and the second power source is formed.

19. The self-examination method of claim 18, wherein micro-controller unit is configured to determine whether the relay and the current transformer are normally operated or not according to a voltage current passing through the current transformer recorded by a meter unit.

20. The self-examination method of claim 11, wherein the checking signal is generated according to a cycle or a user.
